(19) United States
(12) Patent Application Publication
(10) Pub. No.: US 2009/0055418 A1
(43) Pub. Date: Feb. 26, 2009

(54) AUTOMATIC CASCADING COPY OPERATIONS IN A DATABASE WITH REFERENTIAL INTEGRITY

(76) Inventor: Mark Gregory Megerian, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/842,309

(22) Filed: Aug. 21, 2007

(51) Int. Cl. G06F 17/30

(52) U.S. Cl. 707/101; 707/E17.045

(57) ABSTRACT

A method and apparatus for performing a cascading copy operation in a database with referential integrity constraints is disclosed. A user may supply (or be prompted to provide) a new key value, a first table, and a primary key value to use in the cascading copy operation. In response, a database engine may be configured to create a new record in the first table, with a primary key equal to the new key value supplied to the cascading copy operation and otherwise duplicate data values from the row identified by the primary key value. The database engine may also duplicate records in the database in tables other than the first table. Specifically, in one embodiment, records in any table that use the primary key value supplied to the cascading copy operation as a foreign key may be duplicated as a new record having the new key value as the foreign key.

### BACKGROUND OF THE INVENTION

1. Field of the Invention

Embodiments of the invention are generally related to computer database systems. More particularly, embodiments of the invention are related to an automatic cascading copy operation performed in a database with referential integrity constraints.

2. Description of the Related Art

Databases are computerized information storage and retrieval systems. A relational database management system (DBMS) is a computer database management system that uses relational techniques for storing and retrieving data. Relational databases store data using structures that include one or more tables of rows and columns, which may be interconnected. A DBMS typically uses Structured Query Language (SQL) for data definition, data management, and data access and retrieval. A database schema is used to specify how data is stored in a collection of tables and how the tables are related to one another. Using database query languages, such as SQL, data stored in a computer database may be retrieved, updated, and deleted. Updates may include creating or deleting new tables, inserting or deleting rows in an existing table, and copying tables or rows within the database.

Frequently, a relational-database system may employ rules or specify constraints to preserve relationships between tables when records are added to or deleted from the database. Such rules may enforce a relationship between records in different tables to preserve what is commonly referred to as “referential integrity.” For example, a database schema may specify that a row in a “child” table requires a relationship with a row in a corresponding “parent” table (also referred to as a primary key/foreign key relationship). More specifically, a referential integrity constraint specifies that each row in the child table must include a valid reference to a row in the corresponding parent table. A DBMS may be used to maintain consistency between rows of the parent and child tables by enforcing referential integrity constraints. For example, when a row from the parent table is deleted, the DBMS may delete all the rows from the child table that reference the deleted row. If rows in the child table are themselves a parent to records in yet another table, their children are also deleted, and so on. This process is commonly referred to as a “cascading delete.” Cascading updates may be performed in a similar manner.

However, no similar process is available to replicate portions of a parent row (and related child rows) down through a hierarchy of parent, child, and grandchild relationships. Typically, to copy this sort of ‘family tree,’ a user has to identify a given entity (i.e., a primary key) and manually identify the related data to be copied into a new record. Alternatively, an administrator (or other sophisticated user) may write a routine particular to the hierarchy of the table that is the source row of the copy. This requirement makes duplicating portions an existing database entity quite complicated, even though doing so is a logically straightforward operation. For example, consider a case where an organization hires a new employee “A.” Employee A may work in the same office, have the same schedule, and have the same supervisor as an existing employee “B.” To duplicate employee “A's” information in the database in a record for new employee “B”, an administrator may need to research a database schema and write a routine specific to that database. Alternatively, the user may manually copy data related to employee “A” into a new record for employee “B”. Although this process works as intended, it requires data to be manually copied, or a customized routine to be created, for each desired “copy” operation to be performed.

Accordingly, there remains a need in the art for an automatic cascading copy in a database with referential integrity constraints.

### SUMMARY OF THE INVENTION

Embodiments of the present invention may generally be used to perform a cascading copy operation using referential integrity constraints. One embodiment of the invention provides a method of generating records in a database based on referential integrity constraints. The method generally includes receiving a request to perform a cascading copy operation. The request may request may include a new key value, a first table, and a primary key value. The method may also include identifying a first row in the first table having the primary key value, and generating a second row in the first table. The second row in the first table may include a set of data values copied from the first row, except for the primary key value. The method may also include storing the new key value as a new primary key in the second row of the first table and identifying at least one row in a second table that has the primary key value as a foreign key. For each identified row in the second table, an additional row in the second table is generated where each additional row in the second table includes a set of data values copied from one of the identified rows in the second table. The method may also include replacing, in each additional row in the second table, the foreign key value with the new key value, thereby satisfying referential integrity constraints of the database for records created using the new key value.

Another embodiment of the invention includes a computer readable storage medium containing a program which, when executed, performs an operation for generating records in a database based on referential integrity constraints. The operation may generally include receiving a request to perform a cascading copy operation. The request may specify a new key value, a first table, and a primary key value. The operation may also include identifying a first row in the first table having the primary key value and generating a second row in the first table. The second row in the first table includes a set of data values copied from the first row, except for the primary key value. The operation may also include storing the new key value as a new primary key in the second row of the first table and identifying at least one row in a second table that has the primary key value as a foreign key. For each identified row in the second table, an additional row in the second table is generated, where each additional row in the second table includes a set of data values copied from one of the identified rows in the second table. The operation also includes replacing, in each additional row in the second table, the foreign key value with the new key value, thereby satisfying referential integrity constraints of the database for records created using the new key value.

Still another embodiment of the invention includes a system having a processor, a database, and a memory storing a database program configured to perform an operation for generating records in the database based on referential integrity constraints. The database program may be configured to receive a request to perform a cascading copy operation specifying a new key value, a first table, and a primary key value. The program may be further configured to identify a first row in the first table having the primary key value and generate a second row in the first table. The second row in the first table includes a set of data values copied from the first row, except for the primary key value. The program may be further configured to store the new key value as a new primary key in the second row of the first table and identify at least one row in a second table that has the primary key value as a foreign key. For each identified row in the second table, an additional row in the second table is generated. Each additional row in the second table may include a set of data values copied from one of the identified rows in the second table. The program may be further configured to replace, in each additional row in the second table, the foreign key value with the new key value, thereby satisfying referential integrity constraints of the database for records created using the new key value.

Yet another embodiment of the invention includes a method of generating records in a database based on referential integrity constraints. The database may include (i) a first table having a first row of that contains a set of data values including a primary key value and (ii) a second table having one or more rows that each contain a respective set of data values including the primary key value as a foreign key. The method may generally include receiving a request to perform a cascading copy operation. The request may specify a new key value, the first table, and the primary key value. In response to the request the cascading operation is performed. The cascading copy operation may include inserting a second row in the first table, where the inserted row includes the set of data values copied from the first row, except for the primary key value and the new key value as a primary key for the second row. The cascading copy operation may also include inserting an additional row in the second table for each identified row in the second table that has the primary key value as a foreign key. Each additional row in the second table may includes the respective set of data values copied from one of the identified rows in the second table, except for the primary key value, and may also include the new key value as a foreign key in each additional row in the second table.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a client server view of a computing environment and database system, according to one embodiment of the invention.

FIG. 2 is a block diagram illustrating a database schema, according to one embodiment of the invention.

FIG. 3 is a block diagram illustrating rows in a set of database tables, according to one embodiment of the invention.

FIG. 4 is a flow diagram illustrating a method 400 for a database to perform a cascading copy operation, according to one embodiment of the invention.

FIG. 5 is a block diagram illustrating rows in a set of database tables, including rows generated by performing a cascading copy operation, according to one embodiment of the invention.

### DETAILED DESCRIPTION OF THE PREFERRED EMBODIMENTS

Embodiments of the invention are generally directed to an automatic cascading copy operation performed on a database with referential integrity constraints. One embodiment provides a database engine configured to support cascading copy operations. The cascading copy operation allows database records with referential integrity constraints to be easily duplicated. In one embodiment, a cascading copy operation may be performed using a command syntax recognized by the database engine, for example, a “COPYFROM” SQL command. Of course, the command syntax may take many forms, and the examples given herein are provided to illustrate the present invention.

In one embodiment, the database engine may duplicate data from a source row, based on a primary key value supplied to the COPYFROM command, but create a new value for a primary key. If a primary key is defined using data from multiple columns, new values may be assigned for each component of the primary key. Importantly, if the primary key is used as a foreign key in other tables of the database, the database engine may recursively copy data from each child row related to the source row. Thus, the cascading copy operation permits users of a database to perform copies of related rows across tables of a database hierarchy that are otherwise too large and/or too complex to efficiently be copied manually.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Additionally, embodiments of the invention are described herein relative to the widely used SQL query language. However, the invention is not limited to the SQL query language; rather, embodiments of the invention may be adapted to database queries composed in other query languages.

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD- or DVD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

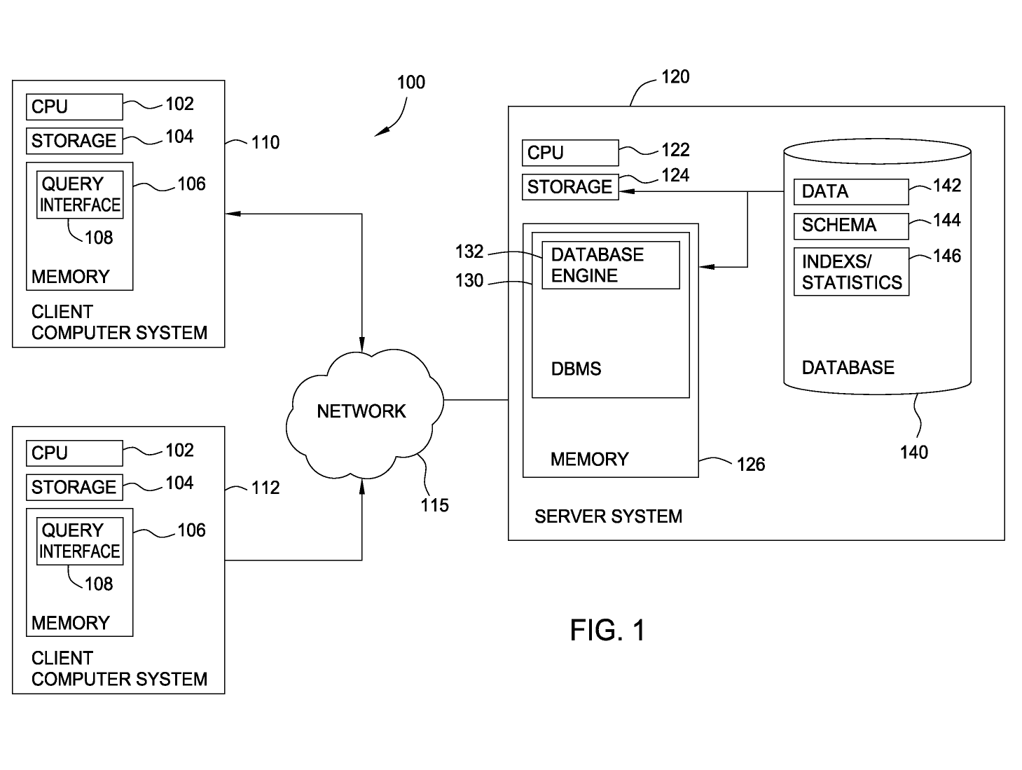

FIG. 1 is a block diagram that illustrates a client server view of computing environment 100, according to one embodiment of the invention. As shown, computing environment 100 includes two client computer systems 110 and 112, network 115 and server system 120. The computer systems 110, 112, and 120 illustrated in environment 100 are included to be representative of existing computer systems, e.g., desktop computers, server computers laptop computers, tablet computers and the like. However, embodiments of the invention are not limited to any particular computing system, application or network architecture and may be adapted to take advantage of new computing systems as they become available. Additionally, those skilled in the art will recognize that the computer systems illustrated in FIG. 1 are simplified to highlight aspects of the present invention and that computing systems and networks typically include a variety of additional elements not shown in FIG. 1.

As shown, client computer systems 110 and 112 each include a CPU 102, storage 104 and memory 106, typically connected by a bus (not shown). CPU 102 is a programmable logic device that performs all the instructions, logic, and mathematical processing performed in executing user applications (e.g., a query tool 108). Storage 104 stores application programs and data for use by client computer systems 110 and 112. Storage 104 includes hard-disk drives, flash memory devices, optical media, network and attached storage devices, and the like. Network 115 generally represents any kind of data communications network. Accordingly, network 115 may represent both local and wide area networks, including the Internet. Client computer systems 110 and 112 also include a query interface 108. In one embodiment, query interface 108 provides a software application that allows users to create, read, update and delete information stored in a database (e.g., database 140). Query interface 108 may allow users to compose and submit SQL commands to a database management system, which, in response, may be configured to process the SQL and return query information, or results of update actions. In one embodiment, a user may issue a command to execute a cascading copy operation through query interface 108.

Server 120 includes a CPU 122, storage 124 and memory 126. As shown, server computer 120 also includes a database management system (DBMS) 130 that includes a database engine 132. Database engine 132 may be used to create, retrieve, update and delete data from database 140, and also be used to perform other database operations. In one embodiment, the actions performed by DBMS 130 may be controlled via query interface 108.

Database 140 stores the data managed by DBMS 130. At various times, elements of database 140 may be present in storage 124 and memory 126. In one embodiment, database 140 includes data 142, schema 144 and indexes/statistics 146. As stated, data 142 represents the substantive data stored by database 140. Schema 144 provides a description of how the data 142 is represented and organized within a database 140. For a relational database, schema 144 specifies the tables, columns, and relationships between tables. In addition, schema 144 may specify the data types of columns in a table and any constraints on a table or column. For example, schema 144 may identify relationships enforced as a referential integrity constraint between tables of database 140. Index/statistics 146 may include various elements of metadata regarding database 140. In one embodiment, schema 144 may be stored in a set of system catalog tables, created and maintained for a given database. As is known, catalog tables typically contain information about the definitions of the database objects (for example, tables, views, indexes, and packages), and security information about the type of access that users have to these objects.

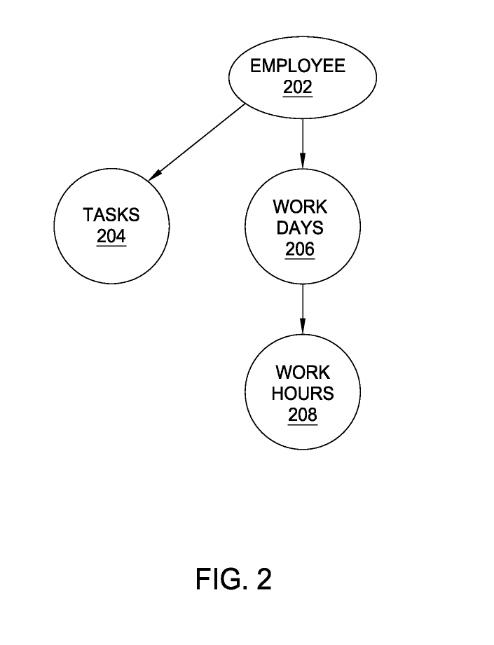

Typically, to duplicate a database record, an administrator has to research database schema 144 and manually copy all the relevant data or write a specialized routine to do the same. Rather than composing a complex routine or copying the information manually, in one embodiment, database engine 132 may access internal catalog tables (part of schema 144) to automatically create a duplicate database record in response to a receiving a command to perform a cascading copy operation. Further, the cascading copy operation may be supplied a number of parameters, such as a source table, a primary key value for the row to be copied from the source table, and a new key value for the new row. In response, the database engine may be configured to create a new record in the source table, with a primary key equal to the new key value supplied to the cascading copy operation and otherwise duplicate data values from the row identified by the primary key value. The database engine may also duplicate records in the database in tables other than the source table. Specifically, in one embodiment, records in any table that use the primary key value supplied to the cascading copy operation as a foreign key may be duplicated as a new record having the new key value as the foreign key. FIGS. 2-5 provide an example of a cascading copy operation performed using an example database.

FIG. 2 is a block diagram illustrating an example database schema 200, according to one embodiment of the invention. As shown, database schema 200 includes an employee table 202, a tasks table 204, a work-days table 206, and a work-hours table 208. FIG. 2 also shows the relationships between tables 202, 204, 206 and 208. In this example, employee table 202 contains rows, each storing information about employees within an organization using a database organized according to database schema 200. Similarly, tasks table 204 contains rows, each row storing information about the individual tasks assigned to an employee identified in employee table 202. Work-days table 206 also contains rows, each row storing information about the individual days an employee works, and work-hours table 208 contains rows, each row storing information about the particular hours an employee works.

Further, in this example, the referential integrity constraints between tables 202, 204, 206, and 208 are as follows: employee table 202 is a parent table to tasks table 204, work-days table 206, and work-hours table 208. Thus, for referential integrity constraints to be satisfied, each row in tasks table 204 and work-days table 206 should include a reference to a valid “employee number” key in employee table 202. Similarly, work-days table 206 is itself a parent to work-hours table 208. In this example, for referential integrity constraints to be satisfied, each row in work-hours table 208 should include a reference to a valid “employee number” key in work-days table 206.

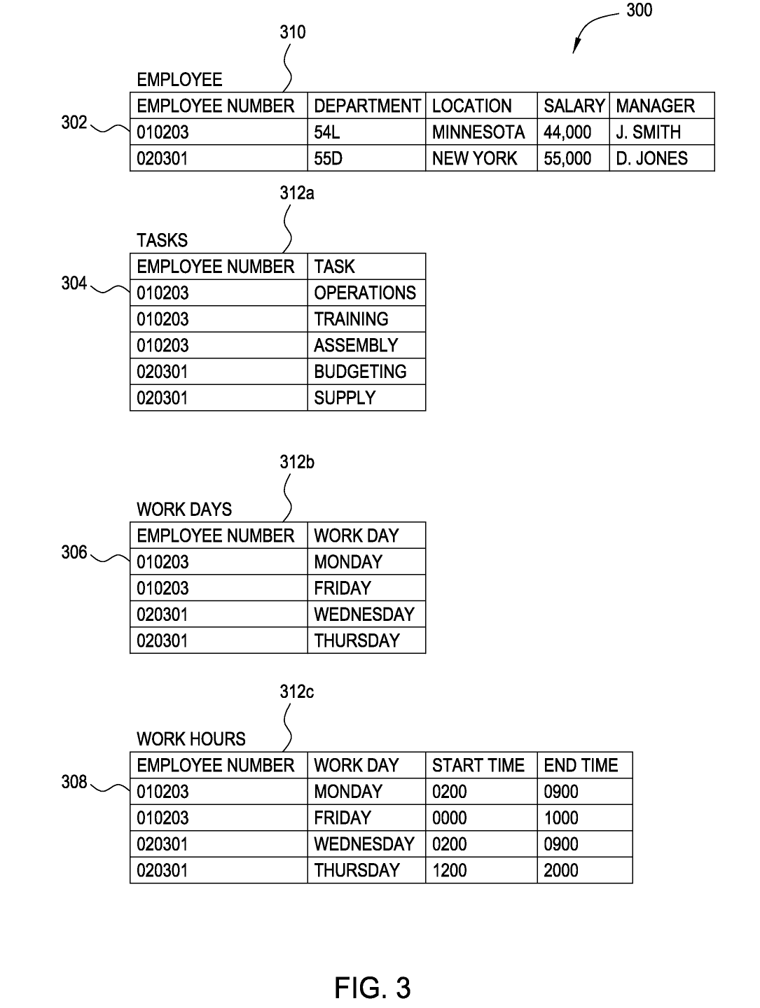

FIG. 3 is a block diagram illustrating a set of tables 300, organized according to database schema 200. Thus, tables 300 include an employee table 302, a tasks table 304, a work-days table 306, and a work-hours table 308. Additionally, employee table 302 includes a primary key column 310 “employee number”, also used as a foreign key in column 312a, and 312b of the tasks-table 204 and work-days table 306. Similarly, work-days table 306 includes a “work-day” column 312b used as foreign key in column 312d of the work-hours table 308.

Employee table 302 includes two rows containing five columns: “employee number,” “department,” “location,” “salary,” and “manager.” Illustratively, the first row in table Employee 302 contains the following values:

| | |
|---|---|
| Employee Number: | 010203 |
| Department: | 54L |
| Location: | Minnesota |
| Salary: | 44,000 |
| Manager: | J. Smith |

Other rows of employee table 302 include similar values related to employees.

Tasks table 304 includes five rows containing two columns, an “employee number” column and a “task” column. In this example, tasks table 304 stores data related to tasks assigned to an employee identified by values in the “employee number” column. For example, the first row in table Tasks 304 contains the following values:

| | |
|---|---|
| Employee Number: | 010203 |
| Task: | Operations |

Thus, the first row in tasks table 304 indicates that an employee with employee number 010203 is assigned the task of “operations.” The second and third rows indicate that this same employee is also assigned tasks of “training,” and “assembly.” The remaining rows of tasks table 304 indicate tasks assigned to another employee (having an employee ID of 020301). In this example, the employee numbers in the rows of tasks table 304 are a foreign key to the column 310 of employee table 302. Thus, for referential integrity constraints to be satisfied, each row in tasks table 304 should contain a value also present in employee table 302. In other words, the values for “employee number” in tasks table 302 are required to exist in column 310 of employee table 302. As shown, the rows of table 304 satisfy this referential integrity constraint.

Similarly, in this example, the employee numbers in the rows of work-days table 306 are a foreign key to column 310 of employee table 302. Thus, the values for “employee number” in work-days table 302 are required to exist in column 310 of employee table 302. As illustrated, work-days table 306 includes two columns, an “employee number” column and a “work day” column. Each row of work-days table 306 stores data related to the working days assigned to a given employee, as indicated by the value in the “employee number” column. For example, the first and second rows in work days table 306 shows that an employee with employee number “010203” works on Monday and Friday.

Work-hours table 308 includes four rows containing four columns. Specifically, work-hours table 308 includes, an “employee number” column, a “work day” column, a “start time,” column, and an “end time” column. Each row of work-hours table 308 include values related to hours worked by a given employee, as indicated by the value in the “employee number” column. For example, the first row in work-hours 308 contains the following:

| | |
|---|---|
| Employee Number: | 010203 |
| Work Day: | Monday |
| Start Time: | 0200 |
| End Time: | 0900. |

Other rows of work-hours table 308 include similar values related to employee work hours. The rows in work-hours table 308 show that employee 010203 works from 0200-0900 hours on Mondays and 0000-1000 hours on Fridays.

When a database administrator needs to create a new record in tables 300, for example, for a new employee, replicating information about an existing employee may be more efficient than creating new rows from scratch for the new employee. For example, a new employee may be assigned the same tasks, the same work days, and the same work hours as an existing employee. In such a case, a user may invoke an embodiment of the cascading copy operation of the present invention. As stated, the user may supply (or be prompted to provide) a source key value to use in the cascading copy operation, along with a new key value to use for the replicated records. The replicated records may include data from the database from records that include the source key value, including records that use the source key value as a foreign key. Further, the replicated records are added to the database using the new key value as a primary/foreign key. Thus, once the cascading copy operation is completed, the database includes complete set of records around the new primary key that satisfies any referential integrity constraints of the database.

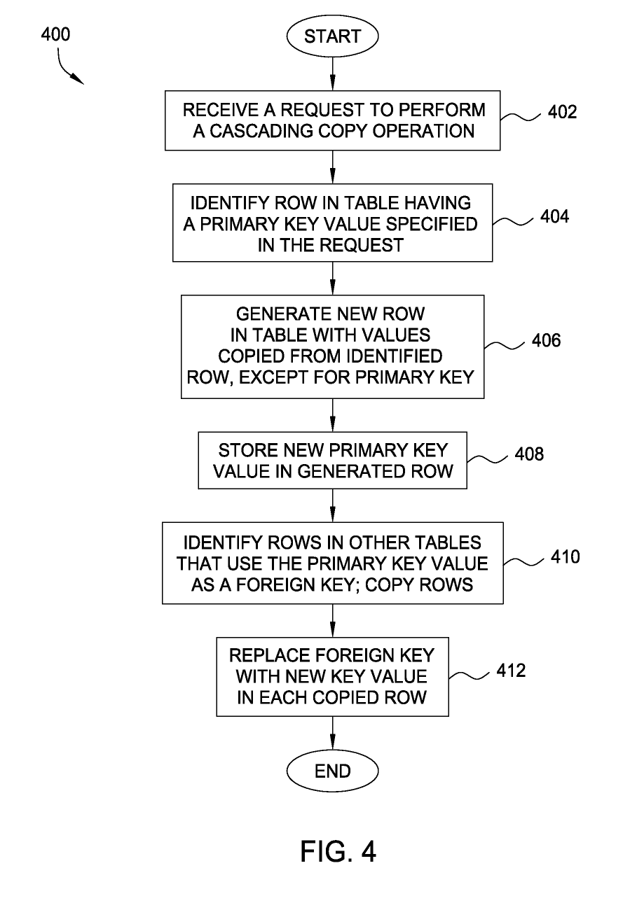

FIG. 4 is a flow diagram illustrating a method 400 for a database to perform a cascading copy operation, according to one embodiment of the invention. As shown, method 400 begins at step 402, where a request to perform a cascading copy operation is received by a database engine. As stated, the request may specify a first table, an existing primary key value to use in performing the cascading copy operation and a new primary key value to use in new database records created during the cascading copy operation. For example, using database schema 200, assume that a request to perform a cascading copy operation is received that identifies an existing primary key value of 010203 from the “employee” table 302 and also includes a new primary key value for a new employee (assume a new key value for the new employee of 067777).

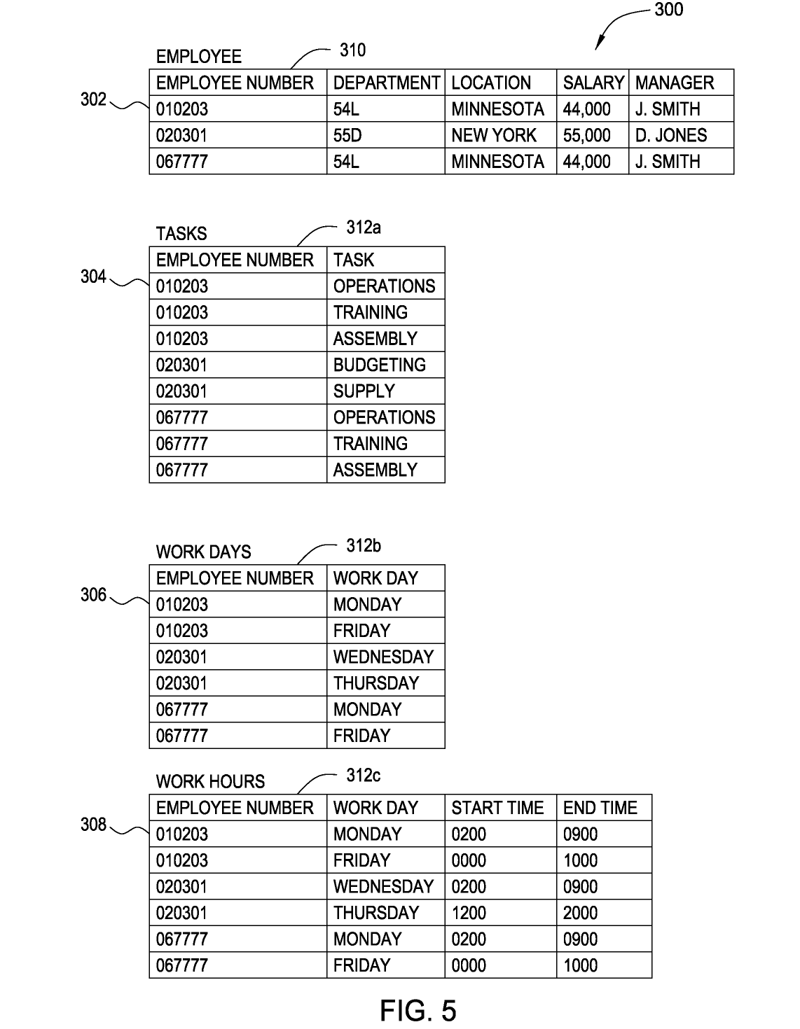

At step 404, the database engine may identify a record in the first table with the primary key value supplied with the request received at step 402. At step 406, the row having this existing primary key value is duplicated, creating a new record in the first table. In one embodiment, the duplicated record includes a copy of each data field from the row having the existing primary key value. At step 408, the primary key value in the new row is replaced with the new key value (e.g., 067777). For example, FIG. 5 shows the result of a cascading copy operation performed using the row of Employee table 302 with the existing key value of 010203. As shown, employee table 302 now includes a row with a primary key value equal to the new key value (i.e., 067777). Except for the primary key column, the new row contains data values copied from the row of the employee table 302 with the primary key value of 010203.

Referring again to FIG. 4, at step 410, the database engine may identify rows in other tables that use the primary key value supplied to the cascading copy operation at step 402 as a foreign key. In one embodiment, the database engine may duplicate each such row in each such table, creating new rows in the database. Additionally, at step 412, the database engine may replace the existing foreign key value (i.e., the existing primary key value supplied to the cascading copy operation at step 402) in each new row with the new key value. For example, FIG. 5 shows tables 302 and 304 with new rows in tasks table 304, work-days table 306, and work-hours table 308. Note that in each of tables 304, 306, and 308, the cascading copy operation has created new rows based on the existing rows with a foreign key value of 010203. However, the foreign key value has been replaced with the new key value of 067777 supplied to the cascading copy operation.

In one embodiment, a user may limit which tables are included in performing a cascading copy operation. That is, the cascading copy operation may be limited to only copying data from tables specified in a parameter supplied to the cascading copy operation. Alternatively, the cascading copy operation may be configured to allow users to specify substitute values in specific tables. For example, the new employee (i.e., 067777) may work the same days, but different hours than the existing employee. In such a case, the user may specify that no new rows should be created in work-hours table 308 for the new employee. In another scenario, the new employee might work in a different department, e.g., a department “54M.” In such a scenario, the new user could specify as a parameter to the cascading copy operation that the “department” column in a row duplicated from employee table 202 should contain the value “54M.”

Advantageously, as the example described above illustrates, data for a new employee may be added to a database based on the simple parameters supplied to the cascading copy operation. At the same time, referential integrity constraints (i.e., each primary key/foreign key relationship) remains satisfied for new records generated by the cascading copy operation. By identifying a row associated with an existing primary key value, a database engine may determine the particular database hierarchy and referential integrality constraints related to that row, and further, the database engine may copy an entire set of records based on the existing primary key value. For each new row, a new primary key value supplied to the cascading copy operation replaces the existing primary key value (whether used as a primary or foreign key). Further, a user may specify that the cascading copy operation should not copy specified tables or include various parameters indicating tables, fields, or values to specify a variety of conditions for a cascading copy operation. For example, conditions such as matching values within fields and substitutions for values from source records may be supplied to the cascading copy operation.

While the foregoing is directed to embodiments of the present invention, other and further embodiments of the invention may be devised without departing from the basic scope thereof, and the scope thereof is determined by the claims that follow.

What is claimed is:

1. A method of generating records in a database based on referential integrity constraints, comprising:
receiving a request to perform a cascading copy operation, wherein the request specifies a new key value, a first table, and a primary key value;
identifying a first row in the first table having the primary key value;
generating a second row in the first table, wherein the second row in the first table includes a set of data values copied from the first row, except for the primary key value;
storing the new key value as a new primary key in the second row of the first table;
identifying at least one row in a second table that has the primary key value as a foreign key;
for each identified row in the second table, generating an additional row in the second table, wherein each additional row in the second table includes a set of data values copied from one of the identified rows in the second table; and
replacing, in each additional row in the second table, the foreign key value with the new key value, thereby satisfying referential integrity constraints of the database for records created using the new key value.

2. The method of claim 1, wherein the primary key value is defined by multiple columns of the first table, and wherein the new key value includes a data value for each of the multiple columns of the first table.

3. The method of claim 1, wherein the request to perform the cascading copy operation further specifies a substitute value for one or more of the set of data values copied from the first row of the first table.

4. The method of claim 1, wherein the request to perform the cascading copy operation further specifies a substitute value for one or more of the set of data values copied from one or more of the identified rows in the second table.

5. The method of claim 1, wherein a referential integrity constraint specifies that each row in the second table must include a valid reference to a key value in a row of the first table.

6. The method of claim 1, wherein the new key value, the first table, and the primary key value are supplied as part of the request to perform the cascading copy operation.

7. The method of claim 1, wherein the new key value, the first table, and the primary key value are supplied in response to prompting a user submitting the request to perform the cascading copy operation.

8. The method of claim 1, wherein the second table is identified using a database catalog that specifies a set of referential integrity constraints defined for the database.

9. A computer readable storage medium containing a program which, when executed, performs an operation for generating records in a database based on referential integrity constraints, the operation comprising:
receiving a request to perform a cascading copy operation, wherein the request specifies a new key value, a first table, and a primary key value;
identifying a first row in the first table having the primary key value;
generating a second row in the first table, wherein the second row in the first table includes a set of data values copied from the first row, except for the primary key value;
storing the new key value as a new primary key in the second row of the first table;
identifying at least one row in a second table that has the primary key value as a foreign key;
for each identified row in the second table, generating an additional row in the second table, wherein each additional row in the second table includes a set of data values copied from one of the identified rows in the second table; and
replacing, in each additional row in the second table, the foreign key value with the new key value, thereby satisfying referential integrity constraints of the database for records created using the new key value.

10. The computer readable storage medium of claim 9, wherein the primary key value is defined by multiple columns of the first table, and wherein the new key value includes a data value for each of the multiple columns of the first table.

11. The computer readable storage medium of claim 9, wherein the request to perform the cascading copy operation further specifies a substitute value for one or more of the set of data values copied from the first row of the first table.

12. The computer readable storage medium of claim 9, wherein the request to perform the cascading copy operation further specifies a substitute value for one or more of the set of data values copied from one or more of the identified rows in the second table.

13. The computer readable storage medium of claim 9, wherein a referential integrity constraint specifies that each row in the second table must include a valid reference to a key value in a row of the first table.

14. The computer readable storage medium of claim 9, wherein the new key value, the first table, and the primary key value are supplied as part of the request to perform the cascading copy operation.

15. The computer readable storage medium of claim 9, wherein the new key value, the first table, and the primary key value are supplied in response to prompting a user submitting the request to perform the cascading copy operation.

16. The computer readable storage medium of claim 9, wherein the second table is identified using a database catalog that specifies a set of referential integrity constraints defined for the database.

17. A system, comprising:
a processor;
a database; and
a memory storing a database program configured to perform an operation for generating records in the database based on referential integrity constraints, by performing the steps of:
receiving a request to perform a cascading copy operation, wherein the request specifies a new key value, a first table, and a primary key value,
identifying a first row in the first table having the primary key value;
generating a second row in the first table, wherein the second row in the first table includes a set of data values copied from the first row, except for the primary key value,
storing the new key value as a new primary key in the second row of the first table,
identifying at least one row in a second table that has the primary key value as a foreign key,
for each identified row in the second table, generating an additional row in the second table, wherein each additional row in the second table includes a set of data values copied from one of the identified rows in the second table, and
replacing, in each additional row in the second table, the foreign key value with the new key value, thereby satisfying referential integrity constraints of the database for records created using the new key value.

18. The system of claim 17, wherein the primary key value is defined by multiple columns of the first table, and wherein the new key value includes a data value for each of the multiple columns of the first table.

19. The system of claim 17, wherein the request to perform the cascading copy operation further specifies a substitute value for one or more of the set of data values copied from the first row of the first table.

20. The system of claim 17, wherein the request to perform the cascading copy operation further specifies a substitute value for one or more of the set of data values copied from one or more of the identified rows in the second table.

21. The system of claim 17, wherein a referential integrity constraint specifies that each row in the second table must include a valid reference to a key value in a row of the first table.

22. The system of claim 17, wherein the request to perform the cascading copy operation further specifies the second table.

23. The system of claim 17, wherein the second table is identified using a database catalog that specifies a set of referential integrity constraints defined for the database.

24. A method of generating records in a database based on referential integrity constraints, wherein the database includes (i) a first table having a first row of that contains a set of data values including a primary key value and (ii) a second table having one or more rows that each contain a respective set of data values including the primary key value as a foreign key, the method comprising:
receiving a request to perform a cascading copy operation, wherein the request specifies a new key value, the first table, and the primary key value;
responsive to the request, performing the cascading operation, comprising:
(i) inserting a second row in the first table, the inserted row including:
the set of data values copied from the first row, except for the primary key value; and
the new key value as a primary key for the second row;
(ii) for each identified row in the second table that has the primary key value as a foreign key, inserting an additional row in the second table, wherein each additional row in the second table includes:
the respective set of data values copied from one of the identified rows in the second table, except for the primary key value; and
the new key value as a foreign key in each additional row in the second table.

25. The method of claim 24, wherein the primary key value is defined by multiple columns of the first table, and wherein the new key value includes a data value for each of the multiple columns of the first table.

26. The method of claim 24, wherein the request to perform the cascading copy operation further specifies a substitute value for one or more of the set of data values copied from the first row of the first table.

27. The method of claim 24, wherein the request to perform the cascading copy operation further specifies a substitute value for one or more of the set of data values copied from one or more of the identified rows in the second table.
